(19) United States
(12) Patent Application Publication
(10) Pub. No.: US 2006/0070559 A1
(43) Pub. Date: Apr. 6, 2006

(54) Unitary currency/credit card unit

(75) Inventors: Robert S. Yoest, Northbrook, IL (US); Fred A. Castillo, Streamwood, IL (US)

Correspondence Address: WELSH & KATZ, LTD, 120 S RIVERSIDE PLAZA, 22ND FLOOR, CHICAGO, IL, 60606, US

(73) Assignee: Incredible Technologies, Inc.

(21) Appl. No.: 11/236,095

(22) Filed: Sep. 27, 2005

Related U.S. Application Data
(60) Provisional application No. 60/614,603, filed on Sep. 30, 2004.

(51) Int. Cl. G07G 5/00

(52) U.S. Cl. 109/24.1

(57) ABSTRACT

A currency/credit card receiving unit is attachable to a vending machine or amusement device with first and second spaced apart flanges. None of the flanges is fixed relative to the unit. The other flange is moveable and is attachable to the unit in a secure region to clamp the unit to the respective vending machine or amusement device. With this configuration all of the retaining fasteners are located in a secure closed region.

### CROSS REFERENCE TO RELATED APPLICATION

This application claims the benefit of the filing date of U.S. Provisional Application Ser. No. 60/614,603 filed Sep. 30, 2004 and entitled “Unitary Coin/Credit Card Unit”.

### FIELD

The invention pertains to coin doors for vending devices or amusement devices. More particularly, the invention pertains to coin doors that provide a higher degree of security for the contents thereof.

### BACKGROUND

Coin door assemblies are known for use on coin-operated machines. These include vending machines, amusement devices such as coin operated arcade games and the like.

Security is always an important issue since such units are either associated with or include coin and/or bill receiving vaults. In this regard it has been known to incorporate heavy protruding bars or hasps and padlocks known to extend across known doors for added security.

Given the importance of keeping such units secure, there is continuing need for improved structures which resist tampering, prying or the like in an attempt to obtain access to the vault. Preferably a higher level of security could be provided without detracting from the appearance of the respective vending machine or amusement device. Further, it would be desirable to be able to readily remove a defective unit, notwithstanding any structure which promotes and improves security, for maintenance purposes.

### BRIEF DESCRIPTION OF THE DRAWING

FIG. 1 is a perspective view of a credit establishing unit in accordance with the invention;

FIG. 2 is a top elevational view of unit of FIG. 1;

FIG. 3 is a side elevational view with a vault illustrated in FIG. 1 removed;

FIG. 4 is a front elevational view of the unit of FIG. 1 with an exterior security door removed;

FIG. 5 is an isometric view of the unit of FIG. 1 with an interior security door opened;

FIG. 6 is an isometric view, in section, of the unit of FIG. 1;

FIG. 7 is a side elevational view of the sectional view of FIG. 6;

FIG. 8 is an isometric view of a frame in accordance with the invention; and

FIG. 9 is a top plan view of the frame of FIG. 8.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

A secure coin door incorporates a generally rectangular frame which carries an interior and an exterior security door. A vault is removably coupled to the frame as well as locking members for locking the unit to a cabinet of a vending machine or amusement device. The locking members can only be accessed when both security doors have been opened.

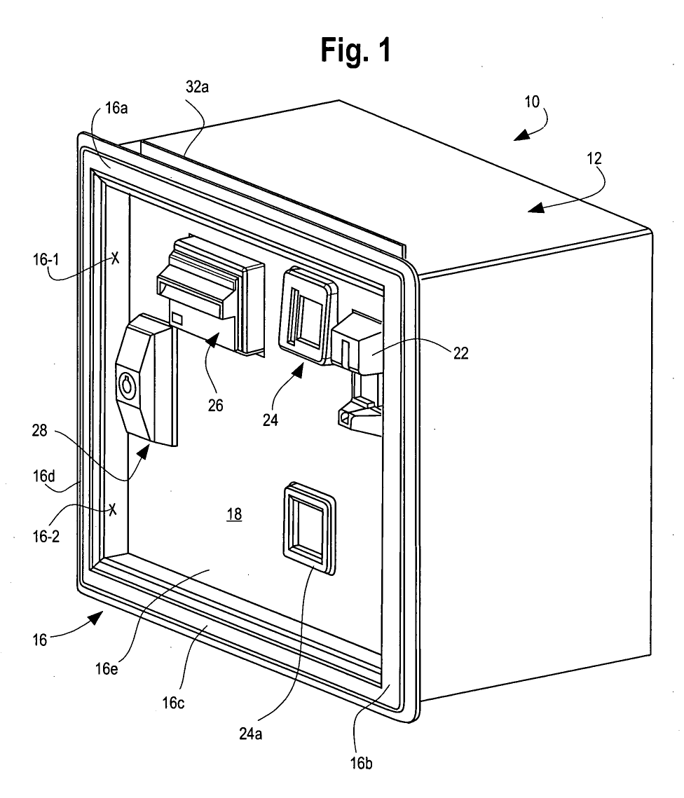

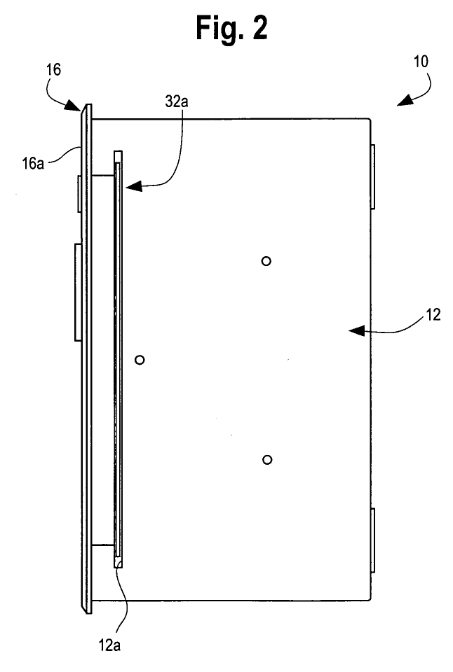

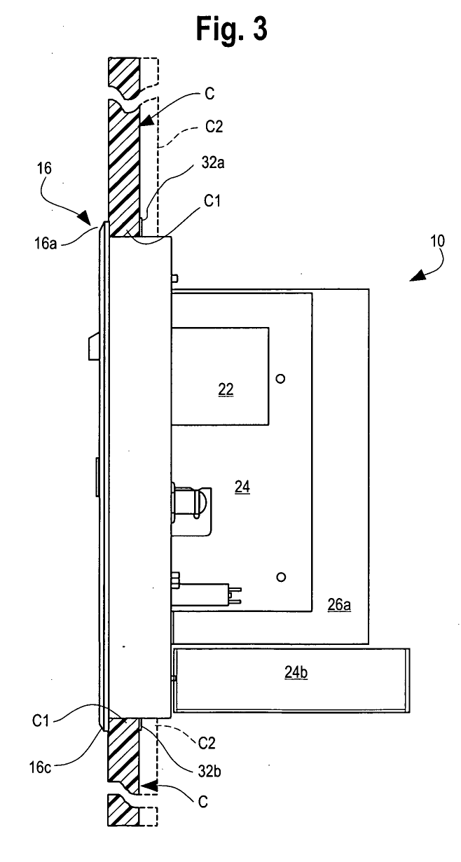

FIGS. 1, 2 and 3 are overall views of a unit 10 in accordance with the invention. FIG. 1 is an isometric view of unit 10 illustrating details of the front thereof as would be seen by a user of the unit or an associated amusement device or vending device. FIG. 2 is a top elevational view of the unit 10. FIG. 3 is a side elevational view of the unit 10 with an exterior cover or vault 12 removed to illustrate various of the details thereof.

The unit 10 includes a generally rectangular, external frame 16 which is removably coupled to the vault 12. An exterior security door 18 is pivotally attached to the frame 16 and recessed therein in a region 16e bounded by the four sides 16a . . . 16d of the frame 16.

Since exterior security door 18 has been recessed within opening 16e of the frame 16 it is very difficult to pry open. Door 18 eliminates any need for exterior protruding bars, or hasps and padlocks which have been used in the prior art to secure coin doors or credit establishing units on vending machines or amusement devices.

The exterior door 18 includes a variety of cutouts or openings through which extend a card reader 22, a coin receiving mechanism 24, a coin return 24a, a bill receiving mechanism 26, a lock 28 illustrated as an exemplary T-handle lock. An individual wishing to establish a credit with associated vending machine or amusement device can use a card with a magnetic strip, such as credit or debit card, coins or bills all of which are accepted by the unit 10. Alternately, an identification card can be inserted into and read by reader 22.

As discussed in more detail subsequently, the unit 10 is clamped or attached to a cabinet C of the associated vending machine or amusement device by a combination of frame sides 16a, 16c and slidable assembly brackets 32a and 32b, best seen in FIG. 3. Cabinet C has an opening O formed therein. The opening O is sized so that the unit 10 will substantially slide into the opening O until the sides 16a . . . 16d of frame 16 contact bounding regions C1 of the cabinet C which stop further travel of the unit 10 into the opening O. The assembly brackets is 32a, b can then be moved into a locking position, illustrated in FIG. 3, to clamp the unit 10 securely to the cabinet C.

The brackets 32a,b incorporate an angle 32c in a range of 90-95 degrees. The preferred angle is on the order of 92 degrees to clamp unit 10 to cabinet C with an increased level of force. In addition, the value of angle 32c, in excess of ninety degrees, takes into account and minimizes any effects due to variations or tolerances in the thickness of the respective cabinet C.

It will be understood that the cabinet C can house any desired variety of vending machine, amusement device or the like all without limitation. Unit 10 is usable with any device which requires the establishment of a pre-activity or pre-purchase credit.

As illustrated in FIG. 2, the vault 12 includes a slot 12a which receives a respective bracket 32a. A similar slot 12b can be positioned for receipt of assembly bracket 32b. With this configuration when the brackets 32a, b are extended to lock the unit 10 to the respective cabinet C, the vault 12 is simultaneously locked thereto and cannot be removed from the interior of the cabinet C. Rather, as discussed below, the vault 12 can only be released from within the unit 10. This is particularly advantageous in that it provides a high degree of security for the funds which may have accumulated in the unit 10 over a period of time.

It will also be understood that the security of the proceeds in the unit can be further increased by, as illustrated in FIG. 3, providing an expansion C2 (illustrated in phantom) to cabinet C such that the assembly brackets 32a,b extend into a slot therebetween. While FIG. 3 illustrates the unit 10 in the absence of vault 12 it will be understood that the extension C2 of cabinet C will overlie, in part, a portion of vault 12 adjacent to the assembly brackets 32a,b thereby making it even more difficult to remove the vault 12 from the unit 10.

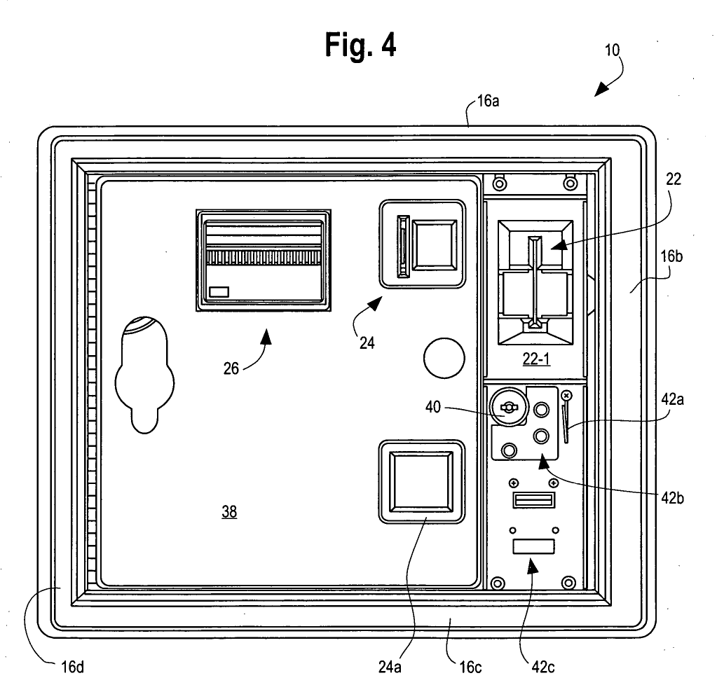

Subsequent to unlocking the lock 28 and opening the door 18 an inner door 38 is exposed. The inner door 38 is also bounded by the four sides of the frame 16, in the opening 16e, as illustrated in FIG. 4. The interior door 38 is locked closed by a second lock 40 which can only be opened with a second, different key. Hence, two different levels of security can be provided.

In one level, a key can be provided for the lock 28 so as to open door 18. This can then make available for maintenance or operational purposes yet another key on hook 42a which could be used to provide access to other areas of cabinet C. An electrically actuated button or buttons, generally indicated at 42b could be provided for maintenance purposes. Finally, one or more meters 42c could be provided for recording machine or device cycles all without limitation.

A second level of security is provided by door 38 and lock 40. Thus, the ability to conduct maintenance in cabinet C can be separated from access to accumulated cash.

As further illustrated in FIG. 4, the interior door 38 provides further security for cash proceeds such as coins received through slot 24 and accumulated in container 24b or bills received via bill accepter 26 and accumulated in container 26a. Additionally, as discussed subsequently, door 38 provides additional security for fasteners for brackets or flanges 32a,b.

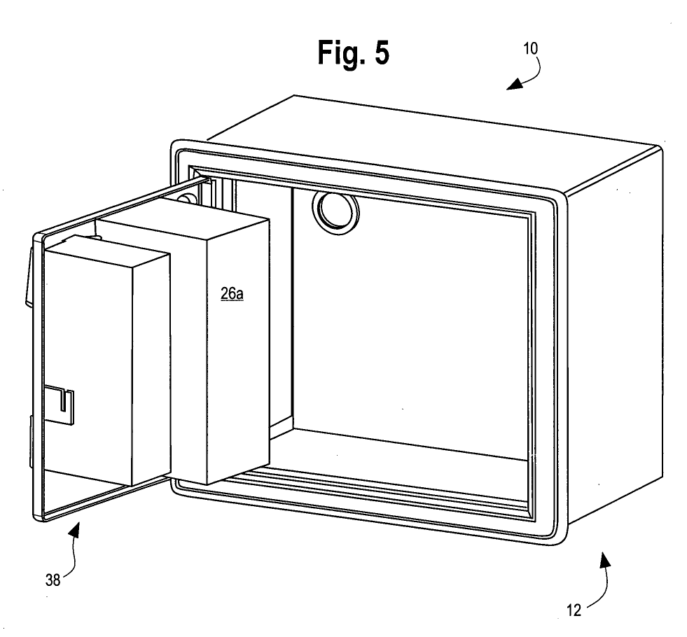

FIG. 5 illustrates unit 10 when the inner security door 38 has been opened. In this condition the currency, the coins in container 24b and bills in container 26a can be accessed and removed. Further, in this state the unit 10 can be released from the associated cabinet C by releasing the locking brackets 32a,b and then withdrawing the unit 10 through the opening O.

In a disclosed embodiment, coin and bill receivers 24, 26 are attached to and carried by door 38. Card reader 22 can be carried by frame 16. The plate 22-1 that carries card reader 22 can be attached to the frame 16 or to the locking brackets 32a,b without limitation. Alternately, it can also be carried on door 38.

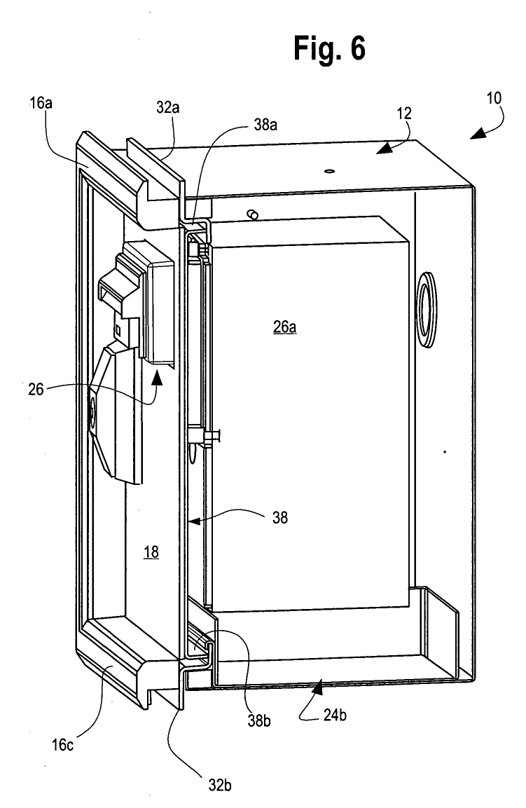

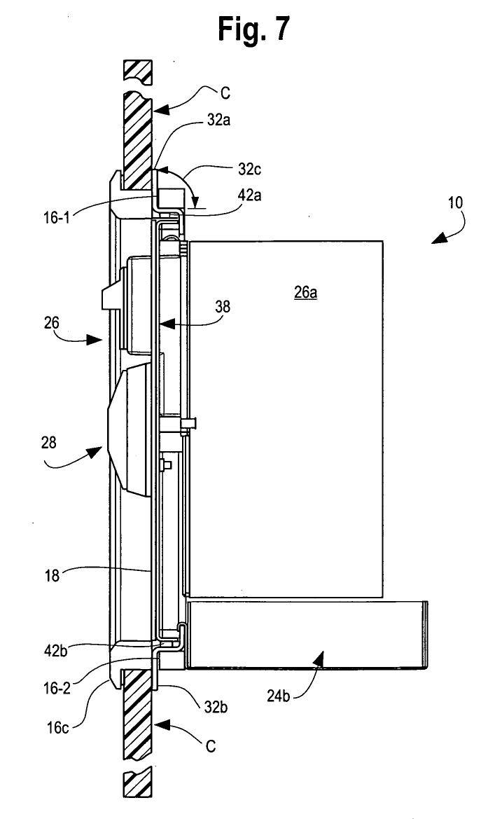

FIGS. 6 and 7 illustrate additional details of the unit 10. As illustrated therein exterior door 18 overlays interior door 38. Door 38 has a U-shaped cross-section for security and strength.

When the interior door 38 is closed, as illustrated in FIGS. 6 and 7, fasteners 42a,b, best seen in FIG. 7, which lock brackets 32a,b into a extended position are covered by ends 38a,b of the door 38. Hence, fasteners 42a,b can only be removed when the door 38 has been opened.

Unit 10 can not be removed where an individual only has access to an interior region of the cabinet C. Unit 10 can only be removed from cabinet C by releasing the fasteners 42a,b which are within the interior of that unit.

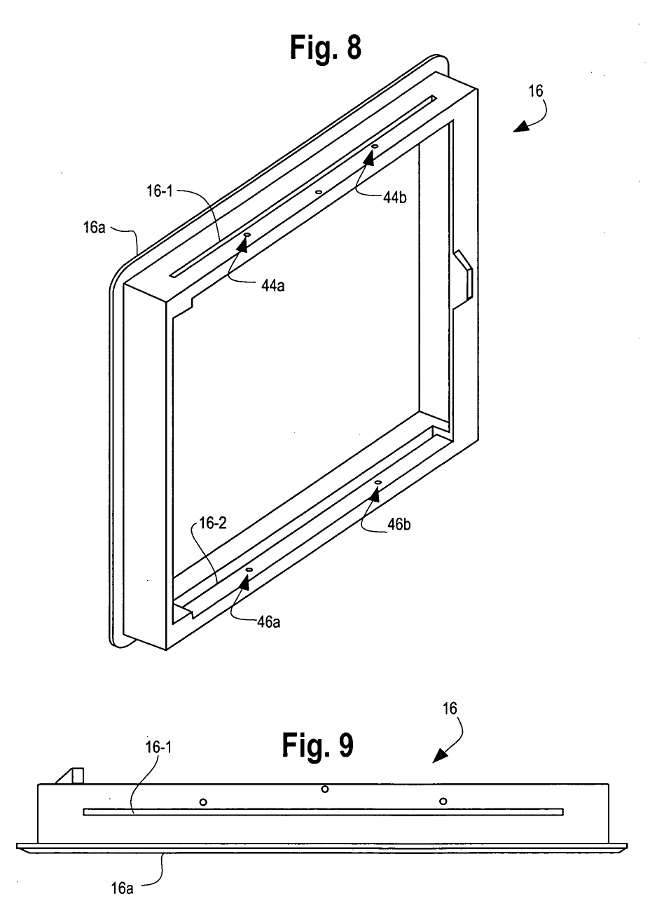

FIGS. 8 and 9 illustrate additional details of frame 16. Frame 16 incorporates slots 16-1, -2 which slidably receive the locking brackets 32a,b, best seen in FIG. 7. Frame 16 also includes fastener receiving openings generally indicated at 44a,b and 46a,b for receipt of respective fasteners such as 42a,b.

Those of skill will understand that while the locking elements 32a,b have been illustrated as slidable brackets, rotatable, cam-like, locking members also come within the spirit and scope of the present invention for purposes of locking the unit 10 to the cabinet C as well as for locking the vault 12 thereto. All such variations come within the spirit and scope of the invention.

If desired, one or more sources of illumination 16-1, -2 can be incorporated into frame 16 to illuminate door 18. Sources of illumination could include one or more light emitting diodes.

Further, while not illustrated, it will be understood that the units 22, 24 and 26 could be electrically coupled to other control circuitry within the respective cabinet C. Such connections do not represent limitations of the present invention. It will also be understood that the unit 10 could be configured so as to be operable as a fully stand alone self-contained unit including its own power supply, if needed and providing only credit establishing outputs to adjacent control circuitry of the cabinet C. All such connection variations come within the spirit and scope of the invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A credit establishing device comprising:
a housing which defines an interior region; and
a first closure that is carried by the housing, the closure has a first position that closes the region and a second, non-closing position, the closure is at least in part recessed in the housing when in the first position, and has an exterior surface relative to the region when in the first position.

2. A device as in claim 1 where the closure is pivotably attached to the housing.

3. A device as in claim 1 which includes a credit establishing unit carried by the housing accessible from the exterior surface of the closure.

4. A device as in claim 3 where the unit is carried, at least in part in the region and in part outside thereof.

5. A device as in claim 3 where the unit is carried by a second closure that is accessible when the first closure is in the second position.

6. A device as in claim 1 which includes an attachment bracket.

7. A device as in claim 6 where the bracket is attachable to a mounting surface defined on the housing.

8. A device as in claim 7 where the mounting surface is accessible only when the first closure is in the second position.

9. A device as in claim 1 where the housing includes a frame which receives the first closure, the closure is recessed in and surrounded by the frame when in the first position.

10. A device as in 9 where the first closure is planar and covers an interior door when in the first position.

11. A device as in claim 10 which includes a mounting bracket, the bracket having at least one fastener opening covered, at least in part, by the first closure when in the first position.

12. A device as in claim 11 where the bracket has, at least in part, first and second sections joined at an angle in a range on the order of ninety to ninety-five degrees.

13. A device as in claim 12 where one section of the bracket is releasibly attached to the housing with a fastener that extends through the at least one fastener opening.

14. A device as in claim 13 with the fastener opening being covered by both the first closure and the interior door when the first closure is in at least the first position.

15. An apparatus comprising:
a cabinet with an opening;
a credit establishing unit sized to be slidably received, at least in part, in the opening, the unit having first and second flanges that trap a portion of the cabinet therebetween.

16. An apparatus as in claim 15 where the first flange extends, at least in part, about a perimeter of the unit and extends beyond the opening to block movement of the unit through the opening.

17. An apparatus as in claim 16 where the second flange is removably attached to the unit.

18. An apparatus as in claim 15 where the unit includes a pivotable door that has first and second positions, the first position is adjacent to the first flange.

19. An apparatus as in claim 18 where the door is recessed relative to the first flange.

20. An apparatus as in claim 18 where the unit defines an interior region and where the door closes the region when in the first position.

21. An apparatus as in claim 20 which includes an interior door between the door and the region.

22. An apparatus as in claim 18 where the unit carries a credit establishing member covered, at least in part, by the door.

23. An apparatus as in claim 22 where the credit establishing member receives at least one of cards, coins or bills.

24. An apparatus as in claim 22 where the second flange is removably attached to the unit.

25. An apparatus as in claim 24 where the first flange extends, at least in part, about a perimeter of the unit and extends beyond the opening to block movement of the unit through the opening.

26. A device comprising:
a vault with an opening for receiving cash receipts;
a frame that surrounds the opening, the frame has a flange that extends, at least intermittently, therefrom;
a movable, locking member that has a locking position and a non-locking position, the locking member when in the locking position in combination with the flange defines a region therebetween, the locking member is, at least intermittently, fixed in the locking position; and
a movable security door coupled to the frame.

27. A device as in claim 26 which includes one of a latch, or fasteners to fix the locking member in the locking position.

28. A device as in claim 27 where one of the latch or fasteners is located between the frame and the vault.

29. A device as in claim 28 where the door has a first position adjacent to the frame and a second displaced, at least in part, position.

30. A device as in claim 29 where the door when in the first position, blocks access to the latch or fastener.

31. A device as in claim 29 where the door is recessed relative to the frame when in the first position.

32. A device as in claim 26 where the door is one of movable or pivotable relative to the frame.

33. A device as in claim 32 which includes at least one pivot coupled to the frame.

34. A device as in claim 26 which includes a T-handle lock carried by the security door.

35. A device as in claim 26 which includes at least one source of illumination, carried by the frame, that illuminates the security door.
